(19) United States
(12) Patent Application Publication
(10) Pub. No.: US 2017/0261468 A1
(43) Pub. Date: Sep. 14, 2017

(54) NETWORK FOR MONITORING BIOMOLECULAR ASSAY

(71) Applicant: C.C. IMEX dba EMBI TEC, San Diego, CA (US)

(72) Inventors: Richard Chan, La Jolla, CA (US); Raymond Chan, San Diego, CA (US)

(21) Appl. No.: 15/063,708

(22) Filed: Mar. 8, 2016

(51) Int. Cl. G01N 27/447

(52) U.S. Cl. CPC G01N 27/44721; H04W 84/12

(57) ABSTRACT

A source smart phone is closely juxtaposed with an electrophoresis running tank assembly and produces real time video images of the gel as the biomolecules migrate through it during electrophoresis. The source smart phone can perform image analysis and compression and then establish a secure WiFi hotspot through which the data output is sent to one or more nearby monitoring smart phones connected to the hotspot, for monitoring the electrophoresis process.

### FIELD

This application relates to networks for monitoring biomolecular assays such as electrophoresis.

### BACKGROUND

The present assignee makes and sells electrophoresis fuming tank assemblies. An example of an electrophoresis running tank assembly is disclosed in U.S. Pat. No. 6,402,915, incorporated here by reference.

Electrophoresis running tanks are used to hold a gel containing biomolecules such as DNA or protein samples and to place a voltage across the gel This causes charged biomolecules to migrate across the gel, separating according to size. The ultimate uses of the biomolecule separation are many.

### SUMMARY

As understood herein, the electrophoresis process must be monitored by a technician during run time to ensure the process is functioning correctly, to determine when the process has completed, etc. This is cumbersome and wasteful of personnel resources.

Accordingly, principles discussed below provide real-time imaging and computer analysis of high resolution images of biomedical samples during electrophoresis using wireless communication devices (WCD) such as smart phones and wearable computing platforms with WiFi capability. Compressed image and analytical results may be streamed live over a WiFi hotspot established by a source WCD simultaneously to multiple end user devices for visualization, annotation and documentation through the secure WiFi hotspot of the source WCD. In this way, (here, is no dependency on external networks such as the Internet of on cellular telephony networks, eliminating infrastructure associated with such networks. Data is delivered securely and in a compressed format for fast delivery of results for end user consumption. The analysis of the electrophoresis process is conducted once, at the source WCD, and consumed anywhere in the WiFi hotspot region. This means that present principles are compatible with any wearable computing platform including any smart phone, and hence one or more portable platforms are provided for analysis, visualization, annotation and documentation of the electrophoresis results. An attractive feature of this approach is the efficiency in support and maintenance of future versions of the operating system (OS) executed by the source WCD and monitoring WCDs. The core application residing on the source WCD does not need to be changed or updated when the OS version changes. The application on the monitoring WCD might need to be changed and updated with newer versions of the OS but these are simpler and less costly.

Accordingly, in one aspect a system for electrophoresis includes at least one electrophoresis assembly including a gel tray configured to hold, a gel therein containing biomolecules. At least one source wireless communication device (WCD) is configured to be closely juxtaposed with the electrophoresis assembly to generate images of the biomolecules as the biomolecules migrate through the gel during electrophoresis and to establish a WiFi hotspot, At least one monitoring WCD is configured to connect to the hotspot to receive data from the source WCD representing the images of the biomolecules migrating through the gel.

In some examples, the source WCD is closely juxtaposed with the electrophoresis assembly in a horizontal orientation above the gel tray to image the gel tray, in other examples, the source WCD is closely juxtaposed with the electrophoresis assembly in a horizontal orientation below the gel tray to image the gel tray. In other implementations, the source WCD is closely juztaposed with the electrophoresis assembly in a vertical orientation parallel to a side of the gel tray to image the gel tray. Benefits of providing for different placements include accommodating focal length which can impact the form factor of the final device, access to the source WCD during quality control or trouble shooting, avoiding condensation during the electrophoresis run which can negatively impact imaging from the top, avoiding the effect of bubbles from the electrode which can negatively affect an image taken from the top, and avoiding mirror image when imaging from the bottom.

In example implementations the source WCD includes a computer memory wife instructions executable by at least one processor to generate at least one image of biomolecules migrating through the gel during -electrophoresis. The instructions can be executable to establish an ad hoc peer to peer communication node by means of the hotspot and to send data representing the image through the node to at least one monitoring WCD.

In non-limiting embodiments the instructions may be executable by the source WCD to undertake one or more of the following: sharpen the image prior to sending the data representing the image through the node, send through the node data representing a progress of electrophoresis, execute color filtering of the image, execute erode and dilation of at least one object in the image, execute image recognition of at least one object in the image to output an analytical .result, and send through the node data representing the analytical result. The WCDs can be established by respective smart phones.

In another aspect, a device includes at least one computer memory that is not & transitory signal and that comprises instructions executable by at least one processor to generate at least one image of biomolecules migrating through a gel during electrophoresis. The instructions, are executable to establish an ad hoe peer to peer communication node and to send data representing the image through the node to at least one recipient wireless communication device (WCD).

In another aspect a method includes disposing a smart phone next to an electrophoresis running tank assembly, and using the smart phone to take at least one image of an electrophoresis process in the electrophoresis assembly. The method also includes using the smart phone to establish a WiFi hot spot, and sending data representing the image through the hot spot to a peer device of the smart phone without using computer network infrastructure or wireless telephony infrastructure.

The details of the present application, both as to its structure and operation, can best be understood in reference to the accompanying drawings, in which like reference numerals refer to like parts, and in which:

### BRIEF DESCRIPTION OF THE DRAWINGS

FIG. 1 is a schematic diagram illustrating monitoring of electrophoresis using a source WCD (such as a smart phone) co-located with an electrophoresis running tank such that one or more nearby technicians can monitor the process without being in arm's reach of the running tank and continually peering into it;

FIG. 2 is a perspective diagram, showing electrophoresis gel being loaded into a tray of an electrophoresis running tank assembly;

FIGS. 3-5 are perspective diagrams illustrating respective techniques for coupling the source WCD to the running tank assembly;

FIG. 6 is a flow chart of example logic that may be executed by the source WCD;

FIG. 7 is a flow chart of example logic that may be executed by a monitoring WCD;

FIG. 8 is a schematic diagram showing a screen shot of the display of a monitoring WCD; and

FIG. 9 is a schematic diagram of a WCD implemented as smart phone, schematically showing internal components.

### DETAILED DESCRIPTION

Present principles leverage wireless computing devices (WCD) such as ubiquitous smart phones as computing platforms for in situ analysis of biological samples. Present principles recognize that smart phones typically are equipped with a high resolution camera, a mature operating system with sophisticated application specific interfaces (APIs), powerful multi-core processors), and ample memory for multi-threaded image processing. Such WCDs also provide reliable and secure transport communication protocol/internet protocol (TCP/IP) network connectivity through the peer-to-peer WiFi protocol, which does not depend on an existing network infrastructure and hence can provide biomedical services even in remote regions or in impoverished regions of the developing countries where connectivity is unavailable. The devices are also handy to be carried round and can run on a power-pack for days, rendering them excellent portable devices for biomedical applications.

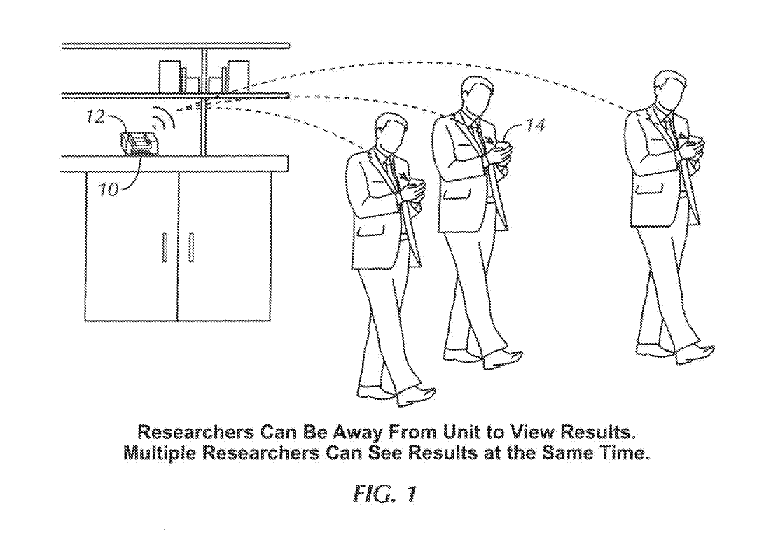

As set forth further below and as shown in FIG. 1, a source WCD 10 images an electrophoresis process with(r) an electrophoresis assembly 12 real time, analyzes the images, and transmits the results to monitoring WCDs 14 for in-situ biomedical analysis. The monitoring WCDs provide visualization, annotation, and documentation via an application (“app”).

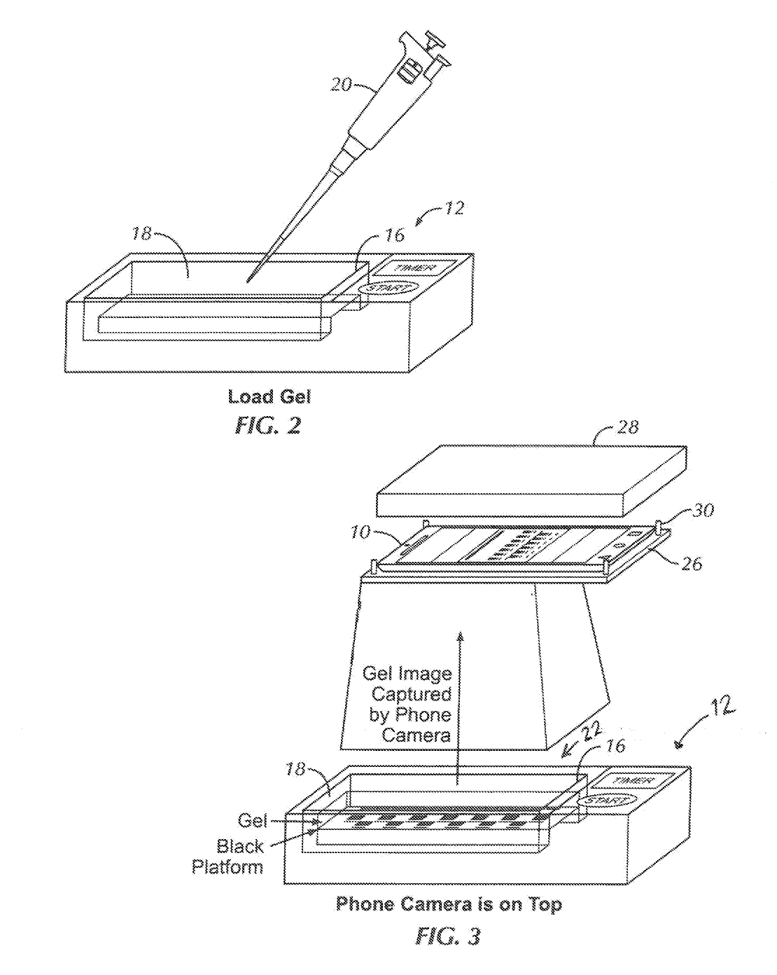

FIG. 2 illustrates an example electrophoresis assembly 12 that includes a running tank 16 holding a liquid buffer and a gel tray 18 holding a gel, into which a substance containing biomolecules such as a protein or DNA can fee loaded using a syringe 20. Voltage is applied to the buffer to influence the molecules to migrate through the gel. The migration time and pattern can be used to identify characteristics of the DNA. Examples of electrophoresis running tank assemblies are disclosed in U.S. Pat. No. 6,402,915 and USPP 2015/0276673, both of which are incorporated herein by reference.

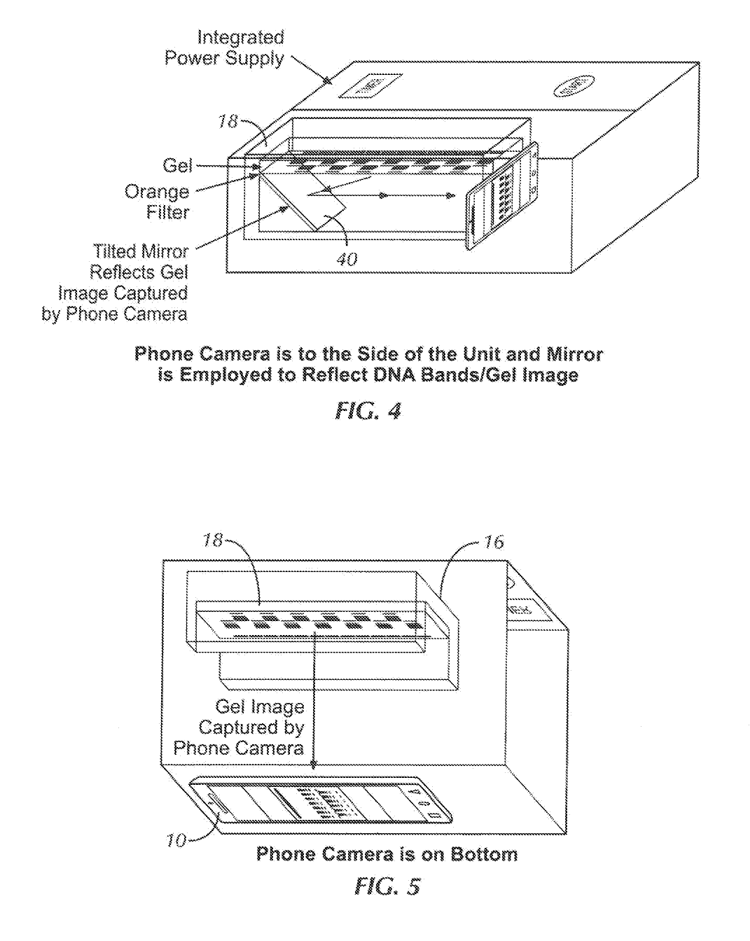

Once the gel tray 18 is disposed in the running tank 16 and loaded with biomolecules such as DNA, the source WCD 10 may be closely juxtaposed with the gel tray to Image the gel tray during electrophoresis. FIGS. 3-5 respectively show that the source WCD may be mounted above, to either one of the sides, and below the gel tray, in various implementations.

In FIG. 3, the source WCD 10 is disposed horizontally above the gel tray 18 with its camera feeing down, in the example shown, the imaged volume is indicated by lines 22. The WCD 10 may be placed flat onto a transparent frame 26 (equivalently, a hollow frame with a central rectilinear opening) and covered by a cover 28 which may include holes registered with pins 30 on the frame 26 to hold the cover 28 onto the frame 26. The covered frame with WCD 10 sandwiched within may then be placed on top of the assembly 12. closely spaced from, the gel tray 18 beneath. The camera of the WCD 10 produces images, either still or video, of the gel as the DNA migrates through it in real time, transmitting data derived from that imaging to the WCDs 14 shown in FIG. 1 through a WiFi hotspot established by the source WCD 10.

FIG. 4 shows that alternatively, the source WCD 10 may be placed in a vertical orientation against a transparent side wall of die naming tank 16 or within the running tank 16. A mount similar to the frame/cover shown in FIG. 3 may be used to hold the WCD 10 against the vertical surface next to which the WCD 10 is positioned. A mirror 40, angled from the vertical as shown, may be positioned on a side of the gel tray 18 opposite the side the WCD 10 is located on to reflect gel/DNA images to the WCD 10.

FIG. 5 shows that the WCD 10 may alternatively be laid fiat horizontally under the naming tank 16 with its camera facing, tip to image the gel/DNA in the gel tray 18.

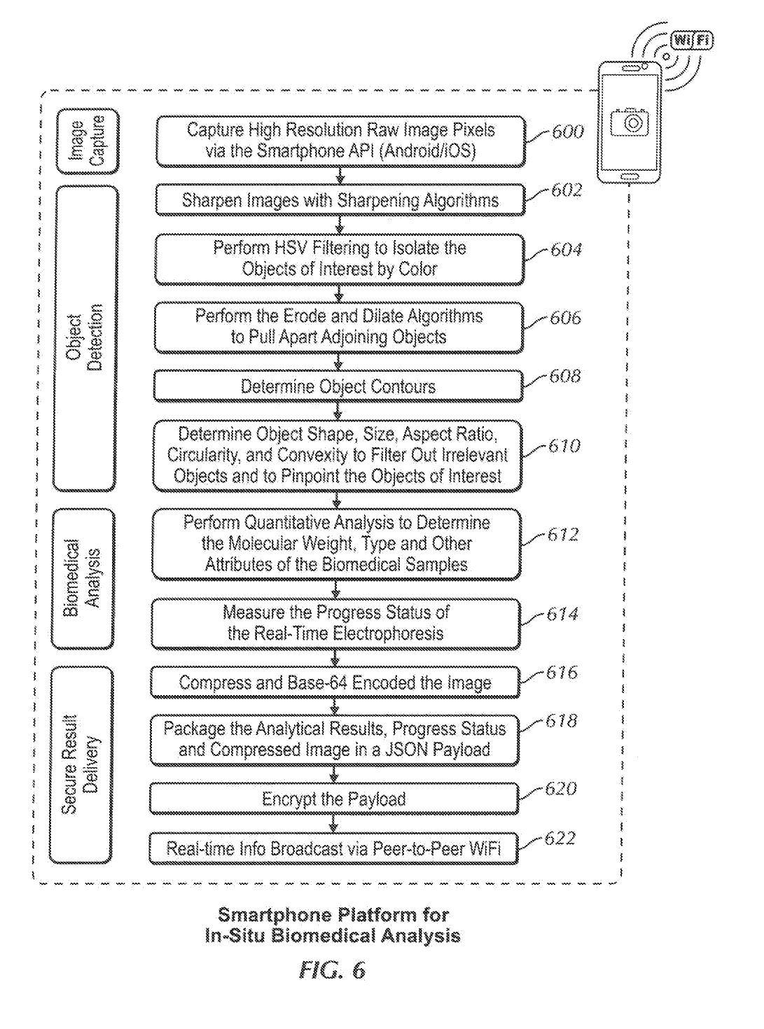

Now referring to FIG. 6, logic associated with a secure service end-point accessible through the peer-to-peer WiFi Hotspot is shown. The source WCD can monitor a predetermined specific socket, port For incoming service requests. To initiate analysis of biological samples, an application executed on one of the monitoring WCDs 14 may connect to the WiFi hotspot established by the source WCD 10. The monitoring WCD 14 may authenticate itself with an authentication credential and if authentication is successful, send a service request in form of an encrypted Javascript object notation (JSON) payload message.

Upon receipt of a valid service request, the source WCD 10 may begin to capture images of the gel/DMA by capturing raw image pixels of live preview frames from the WCD camera. The raw image may be converted into a numerically-based matrix (MAT) data structure to facilitate downstream image processing using open source computer vision (OpenCV) APIs.

At block 602, the images may be sharpened using an image sharpening algorithm. In an example, the image can be sharpened using the Laplacian kernel technique to increase the contest and sharpen the fine details.

Recognizing, that target objects of interest in electrophoresis typically display a unique color spectrum upon excitation by blue light emitting diode (LED) Sight emitted into the gel tray 18, color filtering may be executed on the image at block 604 to isolate the objects of interest signal from background data. Pixel color eats be represented in Red, Green and Blue (RGB) as well as in Hue, Saturation and Value (HSV), which provides a better color model for clean filtering. Hue is essentially the color wheel expressed, in 0-360 degrees. Saturation represents the tint, gradation, and value is the brightness. HSV filtering can foe used to select for pixels in a specific color range and including a wide spectrum of shade and brightness. A binary grayscale MAT is generated from the HSV filtering such that pixels of interest are white and irrelevant pixels are black. The binary image also increases computational efficiency.

Proceeding to block 606, understanding that objects may be touching each other, morphological operations are performed to separate adjoining objects. In one implementation, neighboring pixels are analyzed using image recognition for similarity. When the pixels are determined to be contributed by the adjoining objects, an “erode” operator is applied to the pixel arrays to separate out the overlapping pixels and thereby provide a clean object boundary. This also removes background noise in form of small pockets of positive pixels. A “dilate” operator can then be used to restore the object dimension, so that the size of the objects will not be significantly reduced such that it may decrease below the size detection threshold.

A t block 608 the image is processed for object contour detection. Object contours can be identified using the Border Following algorithm published by Suzuki and Abe in 1985(Suzuki, S. and Abe, K.), “Topological Structural Analysis of Digitized Binary images by Border Following”, CVGIP 30 1, pp 32-46, 1985, incorporated herein by reference.

The Ramer-Douglas-Peucker algorithm is used to reduce the number of points on the contour by virtue of point approximation (Ramer U. An iterative procedure for the polygonal approximation of plane curves. Computer Graphics and Image Processing 1:224-256, 1972, Douglas O. and Peucker T. Algorithms for the reduction of the number of points required for represent a digitized line or its caricature, Canadian Cartographer 10(2); 112-122, 1973.)

Block 610 indicates that various characteristics of the objects of interest in the image may be determined. In example embodiments, the Fitzgibbon algorithm may be used to determine the ellipse that fits the set of contour points in the least-squares manner (Fitzgibbon A. W., Fisher R. B. A Buyer's Guide to Conic Fitting. Proc 5th British Machine Vision Conference, Birmingham pp. 513-522, 1995), incorporated herein by reference. This yields a collection of the rotated rectangles in which an eclipse is inscribed. Using the contour metadata, the WCD 10 determines the shape, size, aspect ratio, circularity and convexity of the objects and pinpoints the objects of interest to facilitate, the biomedical analysis next described.

With greater specificity, in situ biomedical analysis of the image may be executed beginning at block 612. Many different types of biomedical analyses are contemplated. In one example, real-time electrophoresis for separation and identification of DNA molecules using fluorescent stain is analyzed. The DNA ladder and the unknown samples are separated by gel electrophoresis. Based on the DNA ladder revealed, in the image data, the WCD 10 can calculate a mobility coefficient of the fluorescent DNA bands in the image data, construct a standard curve, and determine the molecular weight of the unknown samples. At block 614, the source WCD 10 assesses the progress of the electrophoresis on the basis of the DNA separation, and in some cases by the progress of tracking dyes or other internal markers in each sample. The gel image, progress status and analytic results are broadcast to the monitoring WCDs 14 as described in the sections below.

Note that other applications to which the above techniques may be applied include protein samples analysis using SDS-polyacrylamide gel electrophoresis (SDS-PAGE) and fluorescent dyes. Aside from molecular biology and genetic analysis, the platform, can be used for forensic investigations, vaccine and antibiotics analysis.

Secure result delivery begins at block 616, in which to conserve bandwidth and to ensure secure transmission of the biomedical results, the data payload can be compressed, e.g., with “Gzip” and encrypted to base-64 encoding prior to be broadcast for consumption. Specifically, image pixels are binary and hence can be base-64 encoded into an ASCII string before packaging into the JSON response at block 618 together with the analytical results and the progress status. The payload may be encrypted at block 620 using 256-bit Advanced Encryption Standard (AES) and broadcast peer to peer through the WiFi hotspot hosting the ad hoc peer to peer network to the monitoring WCDs 14 at block 622 in a secure socket stream.

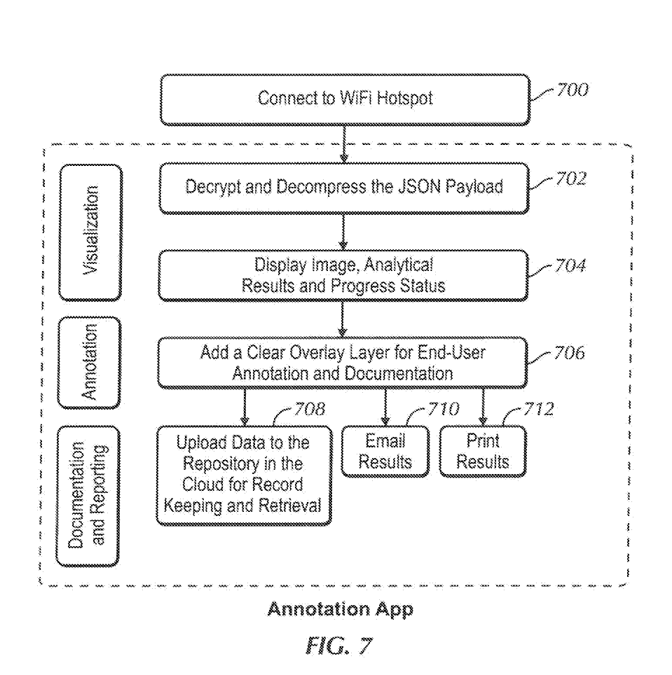

FIG. 7 illustrates logic that may be employed by a monitoring WCD 14 executing an application that enables end users to view, annotate and document the analytical results using their mobile devices once the WCD 14 connects to the WiFi hotspot of the source WCD 10 at block 700. With the broadcasting model through peer-to-peer WiFi, it supports concurrent connections from multiple devices so that experimental results can be shared among colleagues, principal investigators and other pasties of interest to facilitate discussion and collaboration. The app may perform the following series of operations.

When the JSON data payload with the image data described in FIG. 6 is received, at block 702 it is decrypted and decompressed At block 704 the image can be rendered by the WCD 14 executing the annotation app using a native API provided on the mobile devices. The analytical results and the progress status are displayed alongside with the image.

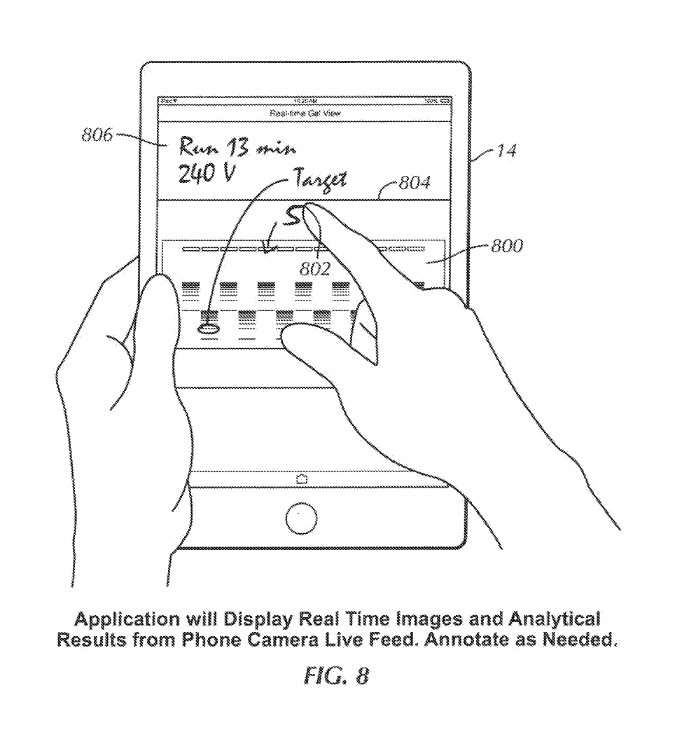

Proceeding to block 706 and referring briefly to FIG. 8, a clear layer can be overlaid on the top of the image 800 sent from the source WCD 10 to allow users to scribble (as indicated at 802) and to add notes. The layer can be powered by a gesture listener which captures user touch events and transforms them into smooth Bezier curves. An advantage of this usability design is that the annotation details are saved along with the image of the sample and the analytical results. FIG. 8 illustrates the display of the analytical results 804 and electrophoresis progress status 806 alongside the image 800 of the gel/DNA in the gel tray 18.

This is a significant value added for the end users to be able to visualize the analysis and to capture written observations in real time.

Various outputs maybe provided on or by the monitoring WCD 14. For example, at block 708 the image and annotation data can be uploaded to a data repository in the cloud and/or a Database Management System (DBMS) for record keeping, or emailed at block 710 to other device that are not part of the peer to peer network, or printed at block 712 for scientific distribution and documentation. Experimental results can also be searched and retrieved from the database via the user interface of the App.

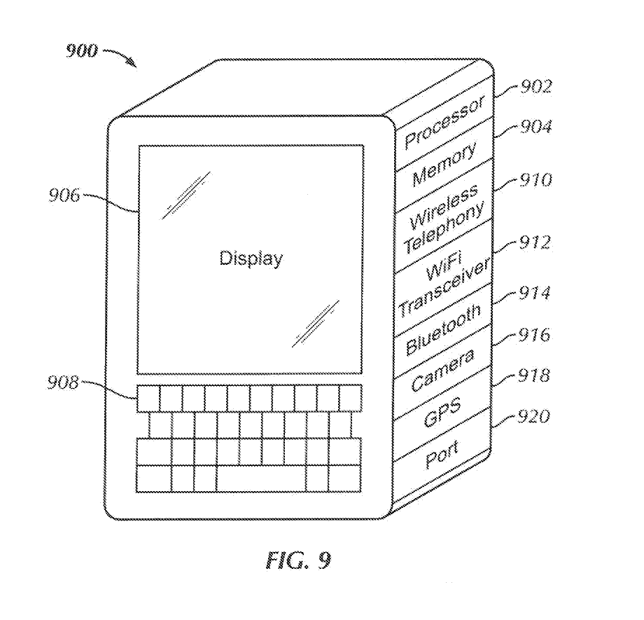

Now referring, to FIG. 9, an example wireless communication device (WCD) is shown that may be used as any of the WCDs divulged above.

A system herein may include components connected over an ad hoc peer to peer network such that data may be exchanged between the components. The components may include one or more computing devices such as smart phones, although other computing devices with peer to peer capability may be used including but not limited to portable televisions (e.g. smart TVs, Internet-enabled TVs), portable computers such as laptops and tablet computers, and other mobile devices. These devices may operate with a variety of operating environments. For example, some of the computers may employ, as examples, operating systems from Microsoft, or a Unix operating system, or operating systems produced by Apple Computer or Google. These operating environments may be used to execute one or more programs or “apps”.

For security, devices herein can include firewalls, load balancers, temporary storages, and proxies. As used herein, instructions refer to computer-implemented steps for processing information in the system. Instructions can be implemented in software, firmware or hardware and include any type of programmed step undertaken by components of the system.

A processor may be any conventional general purpose single- or multi-chip processor that can execute logic by means of various lines such as address lines, data lines, and control lines and registers and shift registers. A processor may be implemented by a digital signal processor (DSP), for example.

Software modules described by way of the flow charts and user interfaces herein can include various sub-routines, procedures, etc. Without limiting the disclosure, logic stated to be executed by a particular module can be redistributed to other software modules and/or combined together in a single module and/or made available in a shareable library.

Present principles described herein can be implemented as hardware, software, firmware, or combinations thereof; hence, illustrative components, blocks, modules, circuits, and steps are set forth in terms of their functionality.

Further to what has been alluded to above, logical blocks, modules, and circuits described below can be implemented or performed with a general purpose processor; a digital signal processor (DSP), a field programmable gate array (FPGA) or other programmable logic device such as an application specific integrated circuit (ASIC), discrete gate or transistor logic, discrete hardware components, or any combination thereof designed to perform the functions described herein. A processor can be implemented by a controller or state machine or a combination of computing devices.

The functions and methods described herein, when implemented in software, can be written in an appropriate language such as but not limited to C# or C++, and can be stored on or transmitted through a computer-readable storage medium such as a random, access memory (RAM), read-only memory (ROM), electrically erasable programmable read-only memory (EEPROM), compact disk read-only memory (CD-ROM) or other optical disk storage such as digital versatile disc (DVD), magnetic disk storage or other magnetic storage devices including removable thumb drives, etc. A connection, may establish a computer-readable medium. Such connections can include, as examples, hard-wired cables including fiber optic and coaxial wires and digital subscriber line (DSL) and twisted pair wires.

Components included in one embodiment can be used in other embodiments in any appropriate combination. For example, any of the various components described herein and/or depicted in the Figures may be combined, interchanged or excluded from other embodiments.

“A system having at least one of A, B, and C” (likewise “a system having at least one of A, B, or C” and “a system having at least one of A, B, C”) includes systems that have A alone, B alone, C alone, A and B together, A and C together, B and C together; and/or A, B, and C together, etc.

Now specifically referring to FIG. 9, a wireless communication device 900 is shown implemented as a computerized “smart” telephone. The WCD 900 can be established by some or all of the components shown in FIG. 1. For example, the WCD 900 can include one or more processors 902 that controls the WCD 900 to undertake present principles, including the other elements of the WCD 900 described herein. The processor 902 may access one or more computer memories 904 that are not transitory signals, such as any of the computer readable media described above. The processor 902 may receive input from one or more input devices such as but not limited to a touch-enabled display 906 and a keypad 908. The processor 902 may output information on the display 906.

When the WCD 900 is implemented as a smart phone, it includes one or more wireless telephony transceivers 910. Without limitation, the transceiver(s) 910 may operate using any one or more of the following principles: code division multiple access (CDMA). w-CDMA, global system for mobile communication (GSM), orthogonal frequency division multiplexing (OFDM), time division multiple access (TDMA), frequency division multiple access (FDMA), space division multiple access (SOMA).

The example WCD 900 may also include one or more wireless data transceivers 912 such as a WiFi transceiver. Also included on the WCD 900 may be a Bluetooth transceiver 914 or other Near Field Communication (NFC) element for communication with other devices using Bluetooth and/or NFC technology, respectively. An example NFC element can be a radio frequency identification (RFID) element.

Continuing the description of the WCD 900, in some embodiments the WCD 900 may include one or more cameras 916 that may be, e.g., a thermal imaging camera, a digital camera such as a webcam, and/or a camera integrated into the WCD 900 and controllable by the processor 24 to gather pictures/images and/or video in accordance with present principles.

In addition to the foregoing, the WCD 900 may also include one or more position or location receivers 918 such as but not limited to a GPS receiver and/or altimeter that is configured to e.g. receive geographic position information horn, at least one satellite and provide the information to the processor 902 and/or determine an altitude at which the WCD 900 is disposed in conjunction with the processor 902. However, it is to be understood that that another suitable position receiver other than a GPS receiver and/or altimeter may be used in accordance with present principles to e.g. determine the location of the WCD 900 in e.g. all three dimensions. Such position information may be included in the imaging data to indicate the location at which the electrophoresis images were obtained.

The WCD 900 may also include input ports 920 such as, e.g., a USB part to physically connect (e.g. using a wired connection) to another CE device and/or a headphone port to connect headphones to the WCD 900 for presentation of audio from the WCD 900 to a user through the headphones. The WCD 900 may include still other sensors such as e.g. one or more climate sensors (e.g. barometers, humidity sensors, wind sensors, light sensors, temperature sensors, etc.) and/or one or more biometric sensors providing input to the processor 902, In addition to the foregoing, it is noted that in some embodiments the WCD 900 may also include a kinetic energy harvester to e.g. charge a battery (not shown) powering the WCD 900.

While the particular NETWORK FOR MONITORING BIOMOLECULAR ASSAY is herein shown and described in detail, it is to be understood that the subject matter which is encompassed by the present invention is limited only by the claims.

What is claimed is:

1. System for electrophoresis, comprising:
at least one electrophoresis assembly including a gel tray configured to hold a gel therein containing biomolecules;
at least one source wireless communication device (WCD) configured to be closely juxtaposed with the electrophoresis assembly to generate images of the biomolecules as the biomolecules migrate through the gel during electrophoresis and to establish a WiFi hotspot: and
at least one monitoring WCD configured to connect to the hotspot to receive data from the source WCD representing the images of the biomolecules migrating through the gel.

2. The system of claim 1, wherein the source WCD is closely juxtaposed with the electrophoresis assembly in a horizontal orientation above the gel tray to image the gel tray.

3. The system of claim 1, wherein the source WCD is closely juxtaposed with the electrophoresis assembly in a horizontal orientation below the gel tray to image the gel tray.

4. The system of claim 1, wherein the source WCD is closely juxtaposed with the electrophoresis assembly in a vertical orientation parallel to a side of the gel tray to image the gel tray.

5. The system of claim 1, wherein the source WCD includes a computer memory comprising instructions executable by at least one processor to:
generate at least one image of biomolecules migrating through the gel during electrophoresis;
establish an ad hoe peer to peer communication node by means of the hotspot; and
send data representing the image through the node to at least one monitoring WCD.

6. The system of claim 5, wherein the instructions are executable to:
sharpen the image prior to sending the data representing the image through the node.

7. The system of claim 5, wherein the instructions are executable to:
send through the node data representing a progress of electrophoresis.

8. The system of claim 3, wherein the instructions are executable to:
execute color filtering of the image.

9. The system of claim 5, wherein the instructions are executable to:
execute erode and dilation of at least one object in the image.

10. The system of claim 5, wherein the instructions are executable to:
execute image recognition of at least one object in the image to output an analytical result.

11. The system of claim 10, wherein the instructions are executable to:
send through the node data representing the analytical result.

12. The system of claim 1, wherein the WCDs are established by respective smart phones.

13. A device, comprising:
at least one computer memory that is not a transitory signal and that comprises instructions executable by at least one processor to:
generate at least one image of biomolecules migrating through a gel during electrophoresis;
establish an ad hoc peer to peer communication node; and send data representing the image through the node to at least one recipient wireless communication device (WCD).

14. The device of claim 13, wherein the instructions are executable to:
sharpen the image prior to sending the data Representing the image through the node.

15. The device of claim 13, wherein the instructions are executable to:
send through the node data representing a progress of electrophoresis.

16. The device of claim 13, wherein the instructions are executable to:
execute color filtering of the image.

17. The device of claim 13, wherein the instructions are executable to:
execute erode and dilation of at least one object in the image.

18. The device of claim 13, wherein the instructions are executable to:
execute image recognition of at least one object in the image to output an analytical result.

19. The device of claim 18, wherein the instructions are executable to:
send through the node data representing the analytical result.

20. A method comprising:
disposing a smart phone next to an electrophoresis running tank assembly;
using the smart phone to take at leas t one image of an electrophoresis process in the electrophoresis assembly;
using the smart phone to establish a WiFi hot spot; and
sending data representing the image through the hot spot, to a peer de vice of the smart phone without using computer network infrastructure or wireless telephony infrastructure.
